(19) United States
(12) Patent Application Publication
(10) Pub. No.: US 2012/0287640 A1
(43) Pub. Date: Nov. 15, 2012

(54) RACK ILLUMINATION DEVICE

(75) Inventor: Feng-Hsiu HSIAO, New Taipei City (TW)

(73) Assignee: Rite-Tech Industrial CO., LTD., Taipei City (TW)

(21) Appl. No.: 13/105,068

(22) Filed: May 11, 2011

(51) Int. Cl. F21V 17/02; F21V 7/00

(52) U.S. Cl. 362/282

(57) ABSTRACT

A rack illumination device is disclosed, wherein a casing is provided with an opening and has a receiving space extending from the opening into the casing, a power module is disposed in the casing and connected to an external power source, and a rotatable lampshade has one end pivotally connected to the casing at a position adjacent to the opening and can be rotated into or out of the casing. When the rotatable lampshade has been rotated into the casing, a switch element is switched to an OFF state to disconnect a light-emitting element from the power module electrically. Once the rotatable lampshade is rotated out of the casing, the switch element is switched to an ON state to make electrical connection between the light-emitting element and power module, thus allowing the light-emitting element to emit light.

### FIELD OF THE INVENTION

The present invention relates to an illumination device, more particularly to a rack illumination device installed in a server rack, so as to enable a network device manager to rotate a rotatable lampshade out of a casing of the rack illumination device and carry out management or maintenance work under light emitted from the rack illumination device.

### BACKGROUND OF THE INVENTION

With the rapid development of information technology, not only have personal computers (e.g., desktop computers and laptop computers) improved significantly, but also electronic business (E-Business) has become a trend. As personal computers are no longer sufficient to satisfy the specific needs of enterprises, professional network devices targeted at these various needs (e.g., firewall servers, network switches, and routers) were developed for business use. Generally, such network devices are installed or received in server racks to facilitate centralized management, with a view to enhancing management efficiency and lowering management costs. In network device management, emphasis is placed on hardware stability as well as software maintenance so as to prevent the network devices from breaking down due to hardware damage, for the network devices must operate 24 hours a day to provide continuous services. Nowadays, it is common practice to place a plurality of server racks in a machine room for centralized management, and the server racks are typically arranged close to one another for the purpose of saving space and making the most use of the machine room.

However, when a network device manager wishing to manage, service, or check on the network devices enters the machine room, the general lighting of the room (e.g., fluorescent lamps) may be insufficient for the manager to see all the network devices in the server racks. This is because the closely arranged server racks tend to prevent the light from illuminating certain racks or certain parts of the racks. Therefore, when the network device manager performs management or maintenance work on the shaded or poorly illuminated network devices, errors in operation or judgment are very likely to occur, which in turn causes the network devices to malfunction. Even worse, irrelevant switches or lines may be inadvertently touched in the dark, thus impairing operation of the network devices and inviting danger.

Therefore, the issue to be addressed by the present invention is to overcome the problems associated with conventional server rack illumination and design an illumination device that can be installed in a server rack and operate without substantially increasing power consumption, so as to facilitate network device management and avoid human errors which may otherwise result from manual operation in the dark.

### BRIEF SUMMARY OF THE INVENTION

In view of the aforesaid drawbacks of conventional server rack illumination, the inventor of the present invention conducted extensive research and experiments and finally succeeded in developing a rack illumination device as disclosed herein. It is intended that the disclosed rack illumination device can, on the premise of not increasing power consumption considerably, provide lighting for the management and maintenance of network devices so that network device managers can avoid operation errors attributable to lack of illumination.

It is an object of the present invention to provide a rack illumination device, wherein the rack illumination device includes a casing, a power module, a rotatable lampshade, and a switch element. The casing is provided with an opening and has a receiving space extending from the opening into the casing. The power module is disposed in the casing and connected to an external power source. The rotatable lampshade has one end pivotally connected to the casing at a position adjacent to the opening such that the rotatable lampshade can be rotated into or out of the casing. In addition, the rotatable lampshade is provided therein with a light-emitting element. The switch element is electrically connected to the power module and can be electrically connectable to the light-emitting element. When the rotatable lampshade has been rotated into the casing, the switch element is switched to an OFF state to disconnect the light-emitting element from the power module electrically; as a result, the light-emitting element cannot emit light. However, once the rotatable lampshade is rotated out of the casing, the switch element is switched to an ON state to make electrical connection between the light-emitting element and the power module, thus allowing the light-emitting element to emit light by drawing electricity from the external power source through the power module. Therefore, a network device manager only has to rotate the rotatable lampshade out of the casing, and he or she can carry out management or maintenance work under the light emitted by the light-emitting element. In this way, the rack illumination device not only saves the electricity required for illumination but also prevents the manager from making mistakes which may otherwise occur due to lack of sufficient illumination.

It is another object of the present invention to provide a rack illumination device, wherein the rack illumination device includes a casing, a power module, a light-emitting element, a reflector plate, and a switch element. The casing is formed with an opening and has a receiving space extending from the opening into the casing. The power module is provided inside the casing and connected to an external power source. The light-emitting element is provided in the casing and corresponds in position to the opening. The reflector plate is pivotally connected to the casing and corresponds in position to the opening. The switch element is disposed in the casing, electrically connected to the power module, and electrically connectable to the light-emitting element. When the reflector plate is received in the opening, the switch element is switched to an OFF state to disconnect the light-emitting element from the power module electrically. However, as soon as the reflector plate is rotated away from the opening, the switch element is switched to an ON state, thereby electrically connecting the light-emitting element and the power module. In consequence, the light-emitting element emits light, and the light is projected on the reflector plate and then reflected outward of the casing by the reflector plate.

### BRIEF DESCRIPTION OF THE SEVERAL VIEWS OF THE DRAWINGS

The structure as well as a preferred mode of use, further objects, and advantages of the present invention will be best understood by referring to the following detailed description of the preferred embodiments in conjunction with the accompanying drawings, in which:

FIG. 1 an exploded perspective view of the first preferred embodiment of the present invention;

FIG. 2 schematically shows the first preferred embodiment of the present invention installed in a server rack;

FIG. 3 is a partial enlarged view of the first preferred embodiment of the present invention;

FIG. 4 is an exploded perspective view of the second preferred embodiment of the present invention;

FIG. 5 is a partial enlarged view of the second preferred embodiment of the present invention;

FIG. 6 is another partial enlarged view of the second preferred embodiment of the present invention; and

FIG. 7 schematically shows the second preferred embodiment of the present invention installed in a server rack.

### DETAILED DESCRIPTION OF THE INVENTION

The inventor of the present invention has long been engaged in the development and design of server racks and illumination devices. In the process, the inventor has found that machine rooms where server racks are situated are typically kept in a no-illumination or low-illumination state to save electricity. Nevertheless, the dark machine rooms may cause problems to the management or maintenance of network devices, for errors in operation or judgment tend to take place in the dark. While attempts have been made in the industry to solve these problems, an ideal solution has yet to be found. In consideration of the above, the inventor came up with the idea of installing a rack illumination device in a server rack, under the condition that the server rack is not to be modified. Thus, a network device manager can perform maintenance or management work under the light emitted by the rack illumination device and avoid incorrect operations or misjudgment attributable to insufficient lighting.

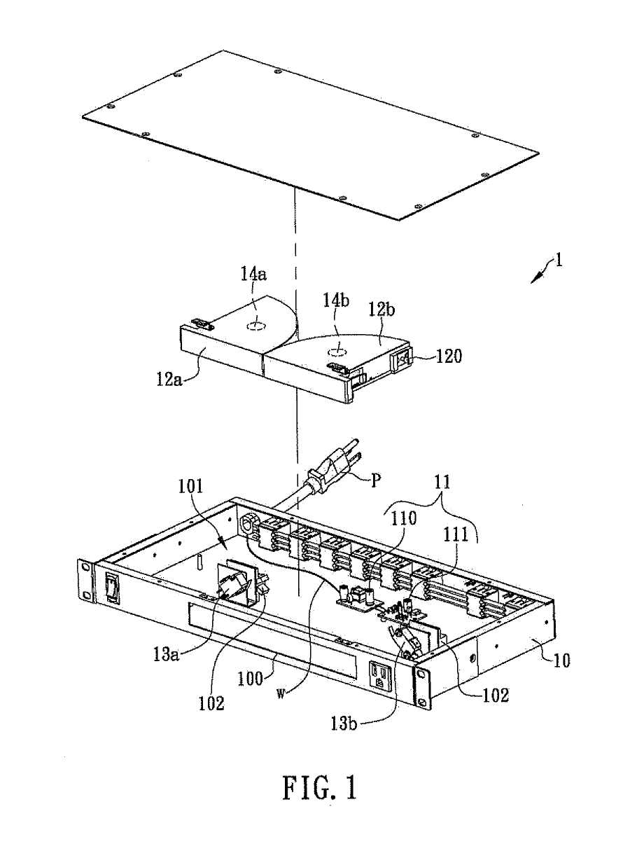

The present invention provides a rack illumination device to be installed in a server rack. Referring to FIG. 1 for the first preferred embodiment of the present invention, the rack illumination device 1 includes a casing 10, a power module 11, two rotatable lampshades 12a, 12b, and two switch elements 13a, 13b. The casing 10, which can be made of metal, is provided with an opening 100 and has a receiving space 101 extending from the opening 100 into the casing 10. The power module 11 is disposed in the casing 10 and includes a transformer 110 and a rectifier 111, wherein the transformer 110 and the rectifier 111 are electrically connected. The transformer 110 is connected to a power wire W. The power wire W extends outward of the casing 10 and has an electrical plug P at the distal end so as to connect with an external power source (not shown). When the electrical plug P is connected to a socket (not shown), the transformer 110 draws electricity through the power wire W, transforms the electric current drawn, and delivers the transformed current to the rectifier 111 for rectification.

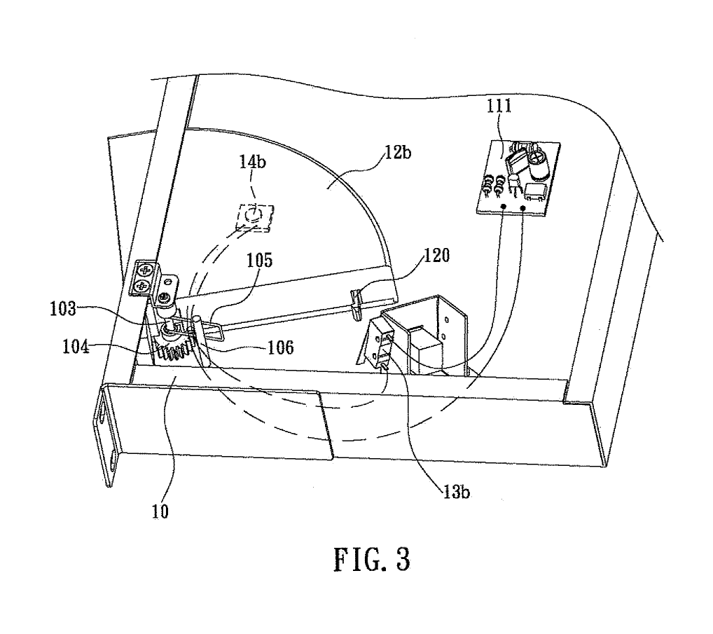

Each of the rotatable lampshades 12a, 12b has one end pivotally connected to the casing 10 at a position adjacent to the opening 100; hence, each rotatable lampshade 12a, 12b can be rotated into or out of the casing 10. Each rotatable lampshade 12a, 12b further has a light-emitting element 14a, 14b therein, and the light-emitting elements 14a, 14b in this preferred embodiment are light-emitting diodes (LEDs). However, the present invention has no limitation on the type of the light-emitting elements 14a, 14b. For example, incandescent light bulbs or other light-emitting elements can be used instead. Furthermore, the switch elements 13a, 13b in the first preferred embodiment are micro switches, and yet the present invention also imposes no limitation on the type of the switch elements 13a, 13b. Switches other than micro switches can be used as well when making the rack illumination device 1 according to the present invention. All variations which are easily conceivable by a person skilled in the art should fall within the scope of the present invention. The switch element 13a is provided in the casing 10 and corresponds in position to the rotatable lampshade 12a. Similarly, the switch element 13b is provided in the casing 10 and corresponds in position to the rotatable lampshade 12b. The switch element 13a is electrically connected to the power module 11 and can be electrically connected to the light-emitting element 14a (e.g., by wires). Likewise, as shown in FIG. 3, the switch element 13b is electrically connected to the power module 11 (or the rectifier 111, to be more specific) and can be electrically connected to the light-emitting element 14b.

With reference to FIG. 1, each rotatable lampshade 12a, 12b has a side that is inside the casing 10 and provided with a first fixing element 120, wherein the first fixing elements 120 are protruding members. On the other hand, the casing 10 is provided therein with second fixing elements 102 that correspond in position to the first fixing elements 120 respectively, wherein the second fixing elements 102 are clamping seats. Once rotated into the casing 10, the rotatable lampshades 12a, 12b press against the switch elements 13a, 13b respectively. Meanwhile, the first fixing elements 120 are engaged with the corresponding second fixing elements 102 respectively to fix the rotatable lampshades 12a, 12b in position in the casing 10. The rotatable lampshades 12a, 12b in this state press against the switch elements 13a, 13b respectively and switch them to an OFF state in which the light-emitting elements 14a, 14b are disconnected from the power module 11 electrically. Thus, failing to draw electricity via the power module 11, the light-emitting elements 14a, 14b cannot emit light.

However, once the rotatable lampshades 12a, 12b are rotated out of the casing 10, either manually or by an automatic control mechanism, the rotatable lampshades 12a, 12b are away from their respective switch elements 13a, 13b. The switch elements 13a, 13b in this state are switched to an ON state in which the light-emitting elements 14a, 14b are respectively and electrically connected to the power module 11 and can therefore emit light by drawing electricity from the external power source via the power module 11.

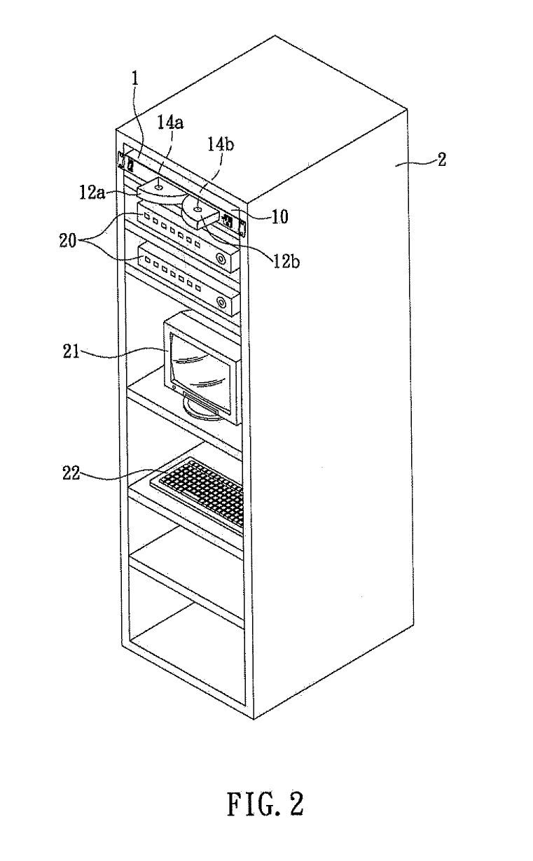

Referring to FIG. 2, the rack illumination device 1 is installed in a server rack 2 and located adjacent to the top end thereof. Also mounted in the server rack 2 are a plurality of network devices 20, a monitor 21, and a keyboard 22. By virtue of the present invention, even if the machine room where several such server racks 2 are located is kept in a no-illumination or low-illumination condition, a manager wishing to manage, service, or check on the network devices in the machine room can move to the front of the intended server rack 2 and rotate the rotatable lampshades 12a, 12b out of the casing 10, causing the light-emitting elements 14a, 14b to emit light onto the other devices in the server rack 2, thus allowing the manager to carry out the intended management or maintenance work under this light without having to turn on the general lighting of the machine room. Accordingly, not only is the electricity required for illumination effectively saved, but also the light can be easily turned off upon completion of the management or maintenance work simply by pushing the rotatable lampshades 12a, 12b back into the casing 10. In short, the rack illumination device 1 features easy operation, can avoid incorrect operations which may otherwise result from lack of illumination, and is effective in preventing network device managers from touching the unintended switches or wires by accident.

Please refer to FIG. 3 for a partial enlarged view of the first preferred embodiment of the present invention. As shown in the drawing, the rotatable lampshade 12b is pivotally connected in the casing 10 by means of a pivot 103, and the pivot 103 is connected with a buffer element 104 at one end. In the first preferred embodiment, the buffer element 104 is a buffer gear, and a torsion spring 105 is mounted around the pivot 103. Apart from that, a fixed post 106 is provided in the casing 10 and adjacent to the pivot 103. Once the rotatable lampshade 12b has been rotated into and fixed in position in the casing 10, one side of the torsion spring 105 is pressed against the fixed post 106 and subjected to force. As a result, the torsion spring 105 undergoes elastic deformation, and elastic potential energy is accumulated in the torsion spring 105. Immediately after the rotatable lampshade 12b is released from the fixed state, the torsion spring 105 exerts a resilient restoring force to push the rotatable lampshade 12b out of the casing 10. With this technical feature, a network device manager only has to pull out the rotatable lampshade 12b slightly, and the rotatable lampshade 12b will automatically pop out, which is very convenient. Alternatively, the rack illumination device 1 may be provided with a press switch (not shown), and pressing the press switch will drive the rotatable lampshade 12b out of the casing 10 automatically. Moreover, as the pivot 103 is connected at one end to the buffer element 104, and the buffer element 104 is configured to buffer the force by which the rotatable lampshade 12b is driven out, the rotatable lampshade 12b is effectively prevented from springing out too forcibly.

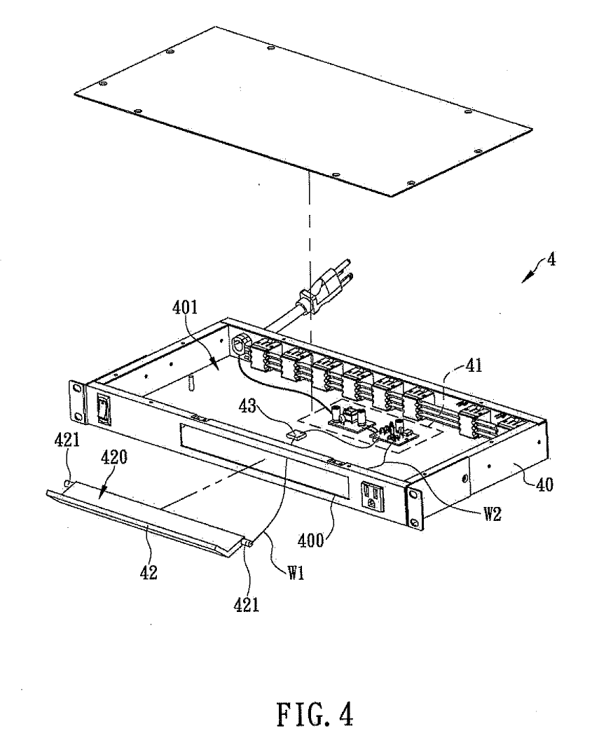

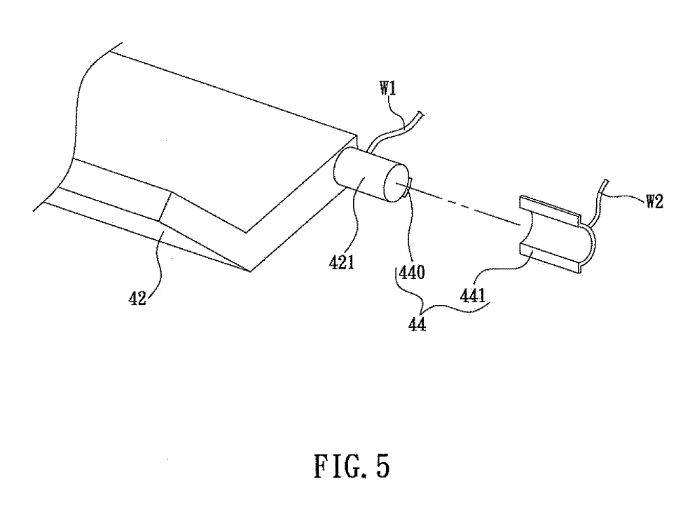

In the second preferred embodiment of the present invention, the rack illumination device 4 has substantially the same hardware structure as in the first preferred embodiment; therefore, only the main technical features of the second preferred embodiment are described as follows. Referring to FIG. 4, the rack illumination device 4 includes a casing 40, a power module 41, a reflector plate 42, a light-emitting element 43, and a switch element 44 (shown in detail in FIG. 5). The casing 40 is provided with an opening 400 and has a receiving space 401 extending from the opening 400 into the casing 40. The light-emitting element 43 is disposed inside the casing 40 and corresponds in position to the opening 400. The reflector plate 42 is curved and has a concave side 420. In addition, two opposite ends of the reflector plate 42 are each protrudingly provided with a pivot 421 while the casing 40 is provided therein with pivot seats (not shown) that correspond in position to the pivots 421 respectively, such that the reflector plate 42 is pivotally connected to the casing 40 and corresponds in position to the opening 400. When the reflector plate 42 has been rotated and received in the opening 400, the concave side 420 of the reflector plate 42 corresponds in position to the receiving space 401 of the casing 40. When the reflector plate 42 is rotated away from the opening 400, the light emitted by the light-emitting element 43 is shone on the concave side 420 of the reflector plate 42 and reflected outward of the casing 40, thereby illuminating the network devices in the server rack. It should be noted that, although the reflector plate 42 in the second preferred embodiment has a curved configuration, the shape of the reflector plate 42 is not limited thereto. For example, the reflector plate 42 may have a plate shape or other shapes while still achieving the intended effects of the present invention.

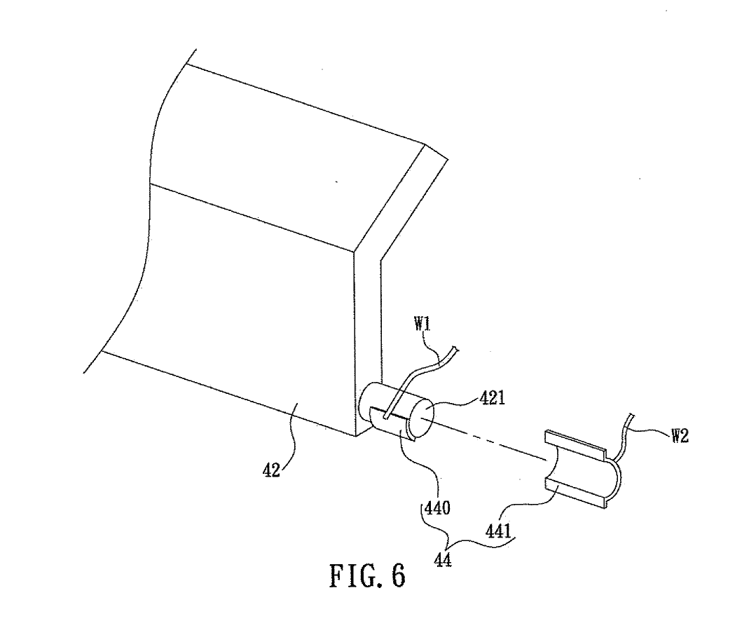

Please refer to FIG. 5 for a partial enlarged view of the second preferred embodiment. As shown in the drawing, the switch element 44 includes a first conductor 440 and a second conductor 441. The first conductor 440 is embedded in the pivot 421. The second conductor 441 is a curved metal plate provided in the casing 40 and is in contact with the pivot 421. An electrical wire W1 is connected to the first conductor 440 at one end and is connected at the other end to the light-emitting element 43 in the casing 40 (see FIG. 4). In addition, an electrical wire W2 is connected to the second conductor 441 at one end and is connected to the power module 41 (see FIG. 4) at the other end. When the reflector plate 42 is rotated to be received in the opening 400, referring to FIG. 6, the first conductor 440 is rotated along with the pivot 421 and is eventually disconnected from the second conductor 441, thus bringing the switch element 44 into an OFF state in which the light-emitting element 43 (see FIG. 4) cannot draw electricity through the power module 41 and therefore cannot emit light. When the reflector plate 42 is rotated away from the opening 400, the first conductor 440 comes into contact with the second conductor 441, thereby switching the switch element 44 to an ON state. As a result, the light-emitting element 43 and the power module 41 shown in FIG. 4 are electrically connected, and the light-emitting element 43 emits light using the electricity supplied through the power module 41.

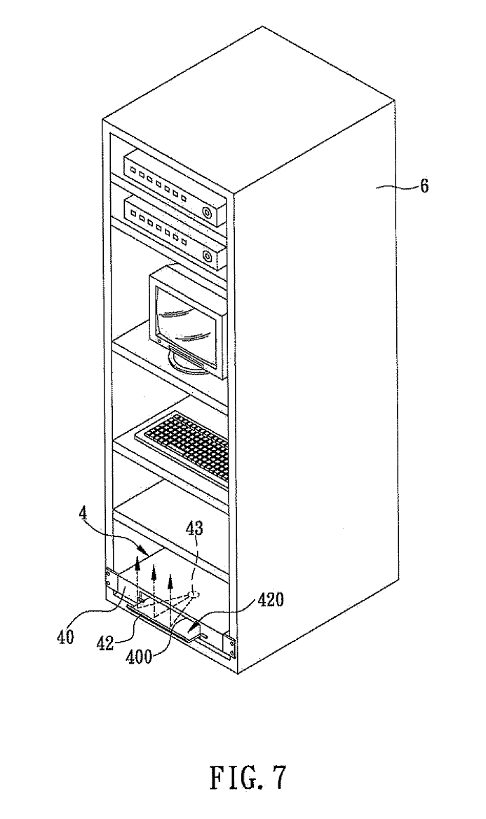

In FIG. 7, the rack illumination device 4 is installed in a server rack 6, with the reflector plate 42 rotated away from the opening 400. Consequently, the switch element 44 shown in FIG. 5 is switched to the ON state, and the light-emitting element 43 is powered to emit light. The light emitted by the light-emitting element 43 is projected on the concave side 420 of the reflector plate 42 and reflected outward of the casing 40 to illuminate the network devices in the server rack 6, thus allowing a network device manager to perform management or maintenance work on the network devices with the light coming from the rack illumination device 4. When the management or maintenance work is done, the light of the light-emitting element 43 can be easily turned off by pushing the reflector plate 42 back to the opening 400 of the casing 40.

It should be pointed out that, when designing and making the rack illumination device according to the contents disclosed herein, the switch element 44 (see FIG. 5) in the second embodiment can also be used in the first preferred embodiment in place of the switch elements 13a, 13b (see FIG. 1) to achieve the intended effects of the present invention. Besides, the switch elements 13a, 13b (see FIG. 1) are equally applicable to the second embodiment, or the torsion spring 105 and the buffer element 104 shown in FIG. 3 can be used in the second embodiment. In addition, the reflector plate 42 may be so designed as to pivot horizontally rather than vertically. All combinations and variations which are readily conceivable by a person skilled in the art should be encompassed by the claims of the present invention.

While the invention has been described by means of specific embodiments, numerous modifications and variations could be made thereto by those skilled in the art without departing from the scope of the invention set forth in the claims.

What is claimed is:

1. A rack illumination device, comprising:
a casing provided with an opening and having a receiving space extending from the opening into the casing;
a power module provided in the casing and connected to an external power source;
a rotatable lampshade having an end pivotally connected to the casing at a position corresponding to the opening such that the rotatable lampshade is rotatable into or out of the casing, wherein the rotatable lampshade is provided therein with a light-emitting element; and
a switch element provided in the casing, electrically connected to the power module, and electrically connectable to the light-emitting element, wherein when the rotatable lampshade has been rotated into the casing, the switch element is switched to an OFF state to disconnect the light-emitting element from the power module electrically, and when the rotatable lampshade is rotated out of the casing, the switch element is switched to an ON state to make electrical connection between the light-emitting element and the power module.

2. The rack illumination device of claim 1, wherein the switch element is provided at a position in the casing that corresponds to the rotatable lampshade such that the rotatable lampshade, once rotated into the casing, presses against the switch element and thereby switches the switch element to the OFF state.

3. The rack illumination device of claim 2, wherein the rotatable lampshade has a side located within the casing and provided with a first fixing element, and the casing is provided therein with a second fixing element corresponding in position to the first fixing element such that, when the rotatable lampshade presses against the switch element, the first fixing element is engaged with the second fixing element to fix the rotatable lampshade in position in the casing.

4. The rack illumination device of claim 3, further comprising a pivot whereby the rotatable lampshade is pivotally connected in the casing, a torsion spring mounted around the pivot, and a fixed post provided in the casing and adjacent to the pivot, wherein when the rotatable lampshade has been rotated into and fixed in position in the casing, one side of the torsion spring is pressed against the fixed post and thereby deforms the torsion spring elastically such that elastic potential energy is accumulated in the torsion spring.

5. The rack illumination device of claim 4, wherein the pivot has an end connected to a buffer element for buffering a resilient force exerted by the torsion spring on the rotatable lampshade.

6. The rack illumination device of claim 1, wherein the rotatable lampshade is pivotally connected in the casing via a pivot, and the switch element comprises a first conductor provided on the pivot and a second conductor disposed in the casing and in contact with the pivot such that, when the rotatable lampshade is rotated away from the opening, the first conductor and the second conductor are in contact and thereby switch the switch element to the ON state.

7. A rack illumination device, comprising:
a casing provided with an opening and having a receiving space extending from the opening into the casing;
a power module provided in the casing and connected to an external power source;
a light-emitting element provided in the casing and corresponding in position to the opening;
a reflector plate pivotally connected to the casing and corresponding in position to the opening; and
a switch element provided in the casing, electrically connected to the power module, and electrically connectable to the light-emitting element, wherein when the reflector plate is received in the opening, the switch element is switched to an OFF state to disconnect the light-emitting element from the power module electrically, and when the reflector plate is rotated away from the opening, the switch element is switched to an ON state to make electrical connection between the light-emitting element and the power module such that the light-emitting element emits light, the light being projected on the reflector plate and reflected thereby outward of the casing.

8. The rack illumination device of claim 7, wherein the reflector plate is pivotally connected to the casing by at least a pivot, and the switch element comprises a first conductor and a second conductor, the first conductor being provided on a said pivot, the second conductor being provided in the casing and in contact with the pivot such that, when the reflector plate is rotated away from the opening, the first conductor and the second conductor are in contact to switch the switch element to the ON state.

9. The rack illumination device of claim 8, wherein the reflector plate is curved and has a concave side, and the concave side corresponds in position to the receiving space when the reflector plate has been rotated into and received in the opening.

10. The rack illumination device of claim 7, wherein the switch element is provided in the casing and corresponds in position to the reflector plate such that, when the reflector plate is received in the opening, the reflector plate presses against the switch element and thereby switches the switch element to the OFF state; and wherein the reflector plate has a side corresponding in position to the casing and provided with a first fixing element, and the casing is provided with a second fixing element corresponding in position to the first fixing element such that, when the reflector plate presses against the switch element, the first fixing element and the second fixing element are engaged with each other to keep the reflector plate received in the opening.
